(19) United States
(12) Patent Application Publication
(10) Pub. No.: US 2024/0429375 A1
(43) Pub. Date: Dec. 26, 2024

(54) SINTERED CATHODES HAVING COATED SURFACES

(71) Applicant: CORNING INCORPORATED, Corning, NY (US)

(72) Inventors: Hoon Kim, Horseheads, NY (US); Darren Lin, Austin, TX (US); Aram Rezikyan, Painted Post, NY (US); Cameron Wayne Tanner, Horseheads, NY (US); Haitao Zhang, Ithaca, NY (US)

(21) Appl. No.: 18/738,195

(22) Filed: Jun. 10, 2024

Related U.S. Application Data
(60) Provisional application No. 63/509,345, filed on Jun. 21, 2023.

(51) Int. Cl. H01M 4/36; H01M 4/02; H01M 4/04; H01M 4/131; H01M 4/505; H01M 4/525; H01M 10/0562

(52) U.S. Cl. CPC H01M 4/366; H01M 4/0428; H01M 4/0471; H01M 4/131; H01M 4/505; H01M 4/525; H01M 10/0562; H01M 2004/021; H01M 2004/027; H01M 2300/0068

(57) ABSTRACT

A battery is provided comprising a coated sintered cathode. The coated sintered cathode comprises at least one of lithium cobalt oxide (LiCoO₂) or NMC (LiNi_{(1-x-y)}MnₓCo_{y}O₂). The coated sintered cathode also comprises a coating layer. The coating layer comprises at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅). The coating layer is coated on the sintered cathode by atomic layer deposition. The sintered cathode may form a cathode-electrolyte interface inside the battery, and the coating layer may be positioned at the cathode-electrolyte interface.

### CROSS REFERENCE TO RELATED APPLICATION

This application claims the benefit of priority under 35 U.S.C. § 119 of U.S. Provisional Application Ser. No. 63/509,345 filed on Jun. 21, 2023, the content of which is relied upon and incorporated herein by reference in its entirety.

### FIELD

Embodiments relate generally to coated sintered cathodes that are formed through an atomic layer deposition process.

### BACKGROUND

Layered rock-salt structures such as lithium cobalt oxide (LCoO₂ or “LCO”) or mixtures of nickel (Ni), manganese (Mn), and cobalt (Co) (“NMC”) have been used as cathode materials for lithium-ion batteries. However, where LCO or NMC materials have been used as cathode materials, the cathode-electrolyte interface instability remains a challenge. Undesired reactions between electroactive transition metals and electrolytes often leads to corrosion at the cathode surface, which causes the electrical capacity of the lithium-ion battery to decline with age and cycling.

Improvements in the foregoing are desired.

### SUMMARY

Various embodiments discussed herein disclose a method to improve the performance of sintered cathodes by coating a layer of inorganic material on an external surface and/or an internal porosity surface of a cathode via processes such as atomic layer deposition (ALD). Testing revealed that a coating layer that is only a few nanometers thick significantly improved the performance of sintered LCO and NMC cathodes. Compared to conventional particulate cathodes, sintered cathodes can provide higher energy densities by removing organic binders and carbon conductors. Moreover, sintered cathodes can provide mechanical support to eliminate additional inactive substrates which are otherwise needed in solid-state battery, and this further improves energy density. The sintered cathode can be prepared as a closed pore structure or an open pore structure by changing sintering conditions. The closed pore structure is denser with a generally closed surface having a porosity of, for example, less than 10 percent. The open pore structure, for example, has an open porosity in a range from about 10% to about 30% with a pore size in a range from about 0.5 to about 2 micrometers. Where open pore structures are utilized, liquid and solid electrolytes may fill the pores in the open pore structure cathode, improving the battery rate performance by reducing lithium-ion diffusion length.

In various embodiments discussed herein, coated sintered cathodes, batteries comprising coated sintered cathodes, and methods for making coated sintered cathodes are provided. Example coated sintered cathodes each comprise a sintered cathode and a coating layer that is formed by ALD. The sintered cathode may comprise a layered rock-salt structure such as LCO and/or NMC (LiNi_{(1-x-y)}MnₓCo_{y}O₂), and the coating layer comprises at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅).

By providing the coating layer, various benefits may be obtained. The coated sintered cathode may be provided inside a battery to improve battery performance. The coating layer separates the cathode and electrolytes in a battery to reduce electrical capacity degradation during cycling and to extend the shelf life of batteries. In some cases, coating layers may prevent the reaction of electrolytes with cathodes before battery cycling. Coating layers can protect the surfaces at interfaces within a battery from unwanted reactions during application of a solid electrolyte material like lithium phosphorus oxynitride (LiPON) or lithium garnet. Thicknesses for coating layers may be selected that are sufficiently thick to be protective without significantly contributing to impedance. Coating layers also provide protection for sintered cathodes from outside handling. The coating layer may also protect internal surfaces of a porous cathode during melt infiltration with a solid electrolyte like LPS (Li₇P₃S₁₁) to create a composite electrolyte. During melt infiltration, some solid electrolytes may be melted and infiltrated into a porous sintered cathode, and the coating layer may be used to protect the cathode from reacting with melted electrolyte.

Coating layers may be formed in coated sintered cathodes through an ALD process. ALD processes may deposit coating materials layer-by-layer at an atomic level. ALD provides good penetration into the pores of a sintered cathode and produces a uniform coating on both external surfaces and internal pore surfaces. ALD is particularly useful for applying coatings with thicknesses between one nanometer and ten nanometers.

In the ALD process, a sintered cathode may be exposed to a precursor material so that precursor material is positioned at exposed surfaces of the sintered cathode, excess precursor material may be purged, and the sintered cathode and remaining precursor material may be exposed to an additive material to cause a coating layer to be formed. Where the precursor material and the additive material are supplied separately, the ALD process is able to effectively control the coating thickness, compositions, and conformality and is also able to achieve good penetration into porous structures. In some embodiments, the precursor material comprises trimethylaluminum (Al(CH₃)₃), the additive material comprises oxygen (O₂) in plasma form, and a reaction between the precursor material and the additive material causes a coating layer comprising aluminum oxide (Al₂O₃) to be formed. In this regard, the oxygen material may be used in plasma form as an oxidant to avoid a chemical vapor deposition (CVD) reaction. Notably, in ALD approaches utilized by others, aluminum oxide (Al₂O₃) is deposited using trimethylaluminum (Al(CH₃)₃) and water. The water is often trapped in the pore and slows out-diffusion, resulting in CVD reactions near the surface of the materials. Additionally, where water is used as an oxidant to form an aluminum oxide (Al₂O₃) coating layer, there is a high concentration of hydroxide (OH). Hydroxide groups often react with electrolytes to form hydrogen fluoride (HF), and the hydrogen fluoride may cause dissolution of the aluminum oxide (Al₂O₃) and cathode materials. Thus, the deposition of a coating layer comprising aluminum oxide (Al₂O₃) using oxygen (O₂) plasma having a short lifetime of radical is better than ALD approaches using water.

In some embodiments, the coating layer may comprise various materials such as aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅). The coating layer may comprise lithium doped aluminum oxide (Al₂O₃), lithium doped aluminum fluoride (AlF₃), and lithium-doped lanthanum oxide (La₂O₃).

In an example embodiment, a coated sintered cathode is provided. The coated sintered cathode comprises a sintered cathode comprising at least one of lithium cobalt oxide (LiCoO₂) or NMC (LiNi_{(1-x-y)}MnₓCo_{y}O₂). The coated sintered cathode also comprises a coating layer. The coating layer comprises at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅). The coating layer is coated on the sintered cathode by atomic layer deposition.

In some embodiments, a thickness of the coating layer may be less than approximately twenty nanometers. Additionally, in some embodiments, the coating layer may define a thickness of between approximately 0.2 nanometers and approximately twenty nanometers.

In some embodiments, the sintered cathode may comprise an open pore structure and a plurality of pores. Additionally, in some embodiments, the sintered cathode may comprise one or more inner pore surfaces, and the coating layer may be coated on the inner pore surface(s). Furthermore, in some embodiments, the porosity of the sintered cathode may be between about ten percent and about thirty percent. In some embodiments, each pore of the plurality of pores have a pore size of about 0.5 micrometers to about 2 micrometers.

In some embodiments, the sintered cathode may comprise a closed pore structure. In some embodiments, the sintered cathode may comprise lithium cobalt oxide (LiCoO₂). In some embodiments, the sintered cathode may comprise NMC 111 (LiNi_{1/3}Mn_{1/3}Co_{1/3}O₂). In some embodiments, the coating layer may comprise at least one of aluminum oxide (Al₂O₃) that is doped with lithium, aluminum fluoride (AlF₃) that is doped with lithium, or lanthanum oxide (La₂O₃) that is doped with lithium.

In some embodiments, the coated sintered cathode may be configured to be used in a battery, and the coated sintered cathode may be configured to cause the battery to have a reduced impedance relative to a battery using an otherwise identical uncoated sintered cathode after fifteen or more charge-discharge cycles have been performed. Additionally, in some embodiments, the coated sintered cathode may be configured to be used in a battery, and the coated sintered cathode may be configured to improve the electrical capacity of the battery relative to a battery using an otherwise identical uncoated sintered cathode.

In some embodiments, the coated sintered cathode also comprises a second coating layer. The second coating layer may comprise at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅). The coating layer and the second coating layer may comprise different materials.

In another example embodiment, a method for coating a sintered cathode by atomic layer deposition to form a coated sintered cathode is provided. The method comprises exposing the sintered cathode to a precursor material, with the sintered cathode comprising a layered rock-salt structure and with the precursor material comprising tricthylaluminium (Al(CH₃)₃). The method also comprises exposing the sintered cathode and precursor material to an additive material, with the additive material comprising oxygen (O₂). Exposing the sintered cathode and remaining precursor material to an additive material causes a coating layer to be formed on the sintered cathode, and the coating layer comprises aluminum oxide (Al₂O₃).

In some embodiments, the sintered cathode may comprise at least one of lithium cobalt oxide (LiCoO₂) or NMC (LiNi_{(1-x-y)}MnₓCo_{y}O₂). In some embodiments, the method may also comprise purging excess amounts of precursor material from the sintered cathode before exposing the sintered cathode and remaining precursor material to the additive material. In some embodiments, the additive material may be provided in plasma form.

In another example embodiment, a battery is provided comprising a coated sintered cathode. The coated sintered cathode comprises at least one of lithium cobalt oxide (LiCoO₂) or NMC (LiNi_{(1-x-y)}MnₓCo_{y}O₂). The coated sintered cathode also comprises a coating layer. The coating layer comprises at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅). The coating layer is coated on the sintered cathode by atomic layer deposition.

In some embodiments, the sintered cathode may form a cathode-electrolyte interface inside the battery, and the coating layer may be positioned at the cathode-electrolyte interface. In some embodiments, the battery may also comprise a solid electrolyte comprising at least one of lithium garnet, lithium phosophosilicate, or lithium phosphorus oxynitride. In some embodiments, the coating layer may comprise a thickness of less than approximately twenty nanometers. Additionally, in some embodiments, the coating layer may comprise a thickness of between approximately 0.2 nanometers and approximately twenty nanometers.

In some embodiments, the sintered cathode may comprise an open pore structure and may comprise a plurality of pores. Furthermore, in some embodiments, the sintered cathode may comprise one or more inner pore surfaces, and the coating layer may be coated on the inner pore surface(s). Additionally, in some embodiments, the porosity of the sintered cathode may be between about ten percent and about thirty percent. In some embodiments, each pore of the plurality of pores may have a pore size of about 0.5 micrometers to about 2 micrometers.

In some embodiments, the sintered cathode may comprise a closed pore structure. In some embodiments, the sintered cathode may comprise lithium cobalt oxide (LiCoO₂). In some embodiments, the sintered cathode may comprise NMC 111 (LiNi_{1/3}Mn_{1/3}Co_{1/3}O₂). In some embodiments, the coating layer may comprise at least one of aluminum oxide (Al₂O₃) that is doped with lithium, aluminum fluoride (AlF₃) that is doped with lithium, or lanthanum oxide (La₂O₃) that is doped with lithium. In some embodiments, the battery may comprise a reduced impedance relative to another battery using an otherwise identical uncoated sintered cathode after fifteen or more charge-discharge cycles have been performed. In some embodiments, the coated sintered cathode may be configured to improve the electrical capacity of the battery relative to a battery using an otherwise identical uncoated sintered cathode. In some embodiments, the battery may also comprise a second coating layer. The second coating layer may comprise at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅). The coating layer and the second coating layer may comprise different materials.

In embodiments, an energy storage device is disclosed, comprising a sintered cathode, a coating layer coated on the sintered cathode and comprising at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅), and wherein a thickness of the coating layer is between about 0.2 nanometers and about twenty nanometers. The coating may encapsulate the sintered cathode. In various embodiments, the sintered cathode may comprise sintered polycrystalline lithium cobalt oxide (LiCoO₂) or NMC (LiNi_{(1-x-y)}MnₓCo_{y}O₂).

In other embodiments, an energy storage device is disclosed, comprising a cathode comprising sintered polycrystalline lithium cobalt oxide (LiCoO₂) and/or NMC (LiNi_{(1-x-y)} MnₓCo_{y}O₂), a coating layer coated on the cathode, and wherein a thickness of the coating layer is between about 0.2 nanometers and about twenty nanometers. In embodiments, the coating may encapsulate the cathode.

### BRIEF DESCRIPTION OF THE DRAWINGS

Having thus described the invention disclosure in general terms, reference will now be made to the accompanying drawings, which are not necessarily drawn to scale, and wherein:

FIG. 1 is a perspective view illustrating an example battery (although any battery shape or type is contemplated herein), in accordance with some embodiments discussed herein;

FIG. 2A is a schematic close-up view illustrating an example sintered cathode having an open pore structure, in accordance with some embodiments discussed herein;

FIG. 2B is a schematic close-up view illustrating the sintered cathode of FIG. 2A after the sintered cathode has been exposed to a precursor material, in accordance with some embodiments discussed herein;

FIG. 2C is a schematic close-up view illustrating the sintered cathode of FIG. 2B after excess amounts of precursor material have been purged, in accordance with some embodiments discussed herein;

FIG. 2D is a schematic close-up view illustrating the sintered cathode of FIG. 2C after the sintered cathode and precursor material are exposed to an additive material, in accordance with some embodiments discussed herein;

FIG. 2E is a schematic close-up view illustrating a coated sintered cathode after the precursor material and the additive material react to form a coating layer on the sintered cathode of FIG. 2D, in accordance with some embodiments discussed herein;

FIG. 2F is a schematic close-up view illustrating the coated sintered cathode after excess material has been purged, in accordance with some embodiments discussed herein;

FIG. 2G is a schematic close-up view illustrating a coated sintered cathode having multiple coating layers, in accordance with some embodiments discussed herein;

FIG. 3A is a scanning transmission electron microscopy (STEM) image illustrating an example coated sintered cathode comprising LCO material, in accordance with some embodiments discussed herein;

FIGS. 3B-3C are enhanced energy-dispersive X-ray spectroscopy (EDS) images illustrating elemental maps for coating layers formed at pores in the coated sintered cathode of FIG. 3A, in accordance with some embodiments discussed herein;

FIG. 4 is a line graph illustrating electrical capacity retention of a battery comprising a coated sintered cathode comprising NMC 111 material and a battery comprising an uncoated sintered cathode comprising NMC 111 material after they each undergo multiple charge-discharge cycles, in accordance with some embodiments discussed herein;

FIG. 5 is a line graph illustrating the resistance of a coated sintered cathode comprising NMC 111 material and an uncoated sintered cathode comprising NMC 111 material after they each undergo multiple charge-discharge cycles, in accordance with some embodiments discussed herein;

FIG. 6A is a STEM image illustrating an example coated sintered cathode comprising NMC 111 material after one hundred charge-discharge cycles, in accordance with some embodiments discussed herein;

FIG. 6B is an enhanced view of the STEM image of FIG. 6A at a first location on the coated sintered cathode, in accordance with some embodiments discussed herein;

FIG. 6C is an EDS image showing an aluminum elemental map taken at the first location on the coated sintered cathode showing retention of a coating layer, in accordance with some embodiments discussed herein;

FIG. 6D is an enhanced view of the STEM image of FIG. 6A at a second location on the coated sintered cathode, in accordance with some embodiments discussed herein;

FIG. 6E is an EDS image showing an aluminum elemental map taken at the second location on the coated sintered cathode showing retention of a coating layer, in accordance with some embodiments discussed herein;

FIG. 6F is an enhanced view of the STEM image of FIG. 6A at a third location on the coated sintered cathode, in accordance with some embodiments discussed herein;

FIG. 6G is an EDS image showing an aluminum elemental map taken at the third location on the coated sintered cathode showing retention of a coating layer, in accordance with some embodiments discussed herein;

FIG. 7 is a flowchart illustrating an example method for coating a sintered cathode by ALD to form a coated sintered cathode, in accordance with some embodiments discussed herein; and

FIG. 8 is a flowchart illustrating another example method for making a sintered cathode using a tape casting slurry.

### DETAILED DESCRIPTION

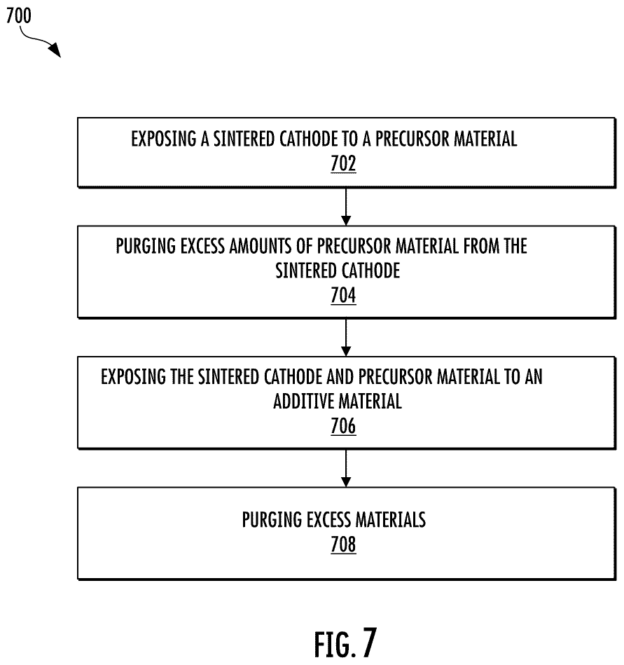

Example embodiments of the present invention disclosure now will be described more fully hereinafter with reference to the accompanying drawings, in which some, but not all embodiments of the invention disclosure are shown. Indeed, the invention disclosure may be embodied in many different forms and should not be construed as limited to the example embodiments set forth herein; rather, these embodiments are provided so that this disclosure will satisfy applicable legal requirements. Other than the reference numbers associated with the flow chart illustrated in FIG. 7, like reference numerals generally refer to like elements throughout. For example, reference numbers 210, 310A, 310B, 610A, etc. are each associated with a coating layer. Additionally, any connections or attachments may be direct or indirect connections or attachments unless specifically noted otherwise. All values for measurements and distances discussed herein are approximated values unless otherwise noted.

As used herein, the singular forms “a,” “an,” and “the” include plural referents unless the context clearly dictates otherwise. Thus, for example, reference to a “component” includes aspects having two or more such components, unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Similarly, the terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, within about 2% of each other, or within about 1% of each other, depending on context.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; the number or type of embodiments described in the specification.

As used herein, a “closed pore structure” has a porosity percentage of less than ten percent. Additionally, as used herein, an “open pore structure” has a porosity percentage of ten percent or more. As used herein, an “otherwise identical uncoated sintered cathode” means an uncoated sintered cathode that does not comprise a coating layer but that is otherwise identical to a coated sintered cathode.

For brevity, ranges of values disclosed herein, including compositional ranges or attribute (performance) ranges, or series of ranges, may be appended by the phrase “including all ranges and subranges therebetween,” which is to be interpreted as including whole number or decimal subranges as though explicitly presented. Thus, by way of example, a range between 6 and 8 (units omitted) implicitly includes a subrange between 6.4 and 8, or a subrange between 6 and 7.2, or a subrange between 6 and 7, and so forth. Additionally, a series of ranges, such as “in a range from 6 to 11 or in a range from 6 to 8” implicitly includes a range from 7 to 10, or subranges therebetween, such as 7.2 to 10.4, as though explicitly presented, provided the range does not exceed the minimum or maximum endpoints of the explicitly presented range or series of ranges. Thus, for example, “in a range from 6 to 11 or in a range from 6 to 8” has as endpoints 6 and 11.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

In various embodiments, coated sintered cathodes are disclosed having a coating layer that may provide several benefits. For example, the coating layer may cause batteries with a coated sintered cathode to have a reduced impedance relative to batteries with otherwise identical uncoated sintered cathodes, particularly after repeated usage of the coated sintered cathode. Additionally, the coating layer may cause batteries with a coated sintered cathode to have an improved electrical capacity relative to similar batteries with a sintered cathode that does not have a coating layer, particularly after repeated usage of the batteries. The coating layer may also provide protection against unwanted reactions during application of a solid electrolyte material such as lithium garnet, lithium phosophosilicate, or lithium phosphorus oxynitride.

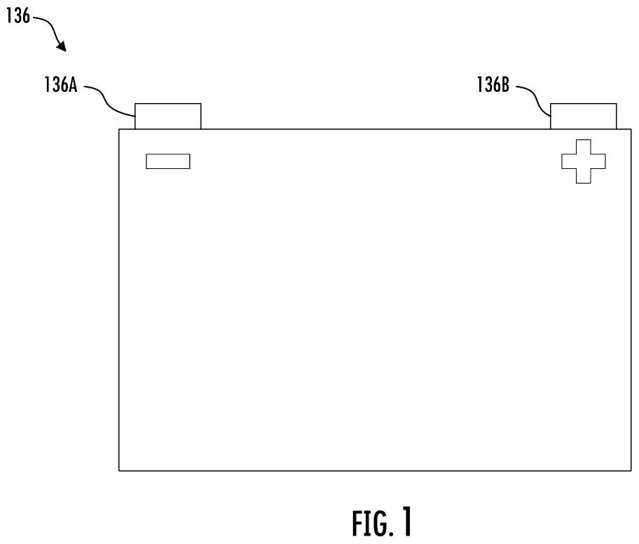

The coated sintered cathodes may be utilized in various applications. For example, as illustrated in FIG. 1, the coated sintered cathodes may be utilized in an energy storage device, e.g., a battery. FIG. 1 illustrates a battery 136. The battery 136 comprises a first external interface 136A and a second external interface 136B. The external interfaces 136A, 136B may serve as interfaces between the battery 136 and an electrical circuit. The first battery 136 may include a coated sintered cathode in the inner contents of the battery 136. The coated sintered cathode, for example, may be provided at a cathode-electrolyte interface inside of the battery 136. These cathode-electrolyte interfaces are often bottlenecks within batteries and are often potential failure points for batteries. However, coating layers may be provided at the cathode-electrolyte interfaces of the battery 136. The coated sintered cathodes may help reduce the likelihood of failure in the battery 136, improve the electrical capacity retention of the battery 136 over time, and provide other benefits of coated sintered cathodes described herein. The battery 136 may be a lithium ion battery in some embodiments, and the battery 136 may also comprise solid electrolytes such as lithium garnet, lithium phosophosilicate, lithium phosphorus oxynitride, etc. Notably, other types and shapes of batteries are contemplated for use with coated sintered cathodes. For example, “button” type battery cells may be used. While the coated sintered cathodes may be utilized in the battery 136 in FIG. 1, the coated sintered cathode may be applied for other purposes. Additionally, while coated sintered cathode(s) are used in the battery 136 in FIG. 1, the coated sintered cathode(s) may be used in other types of batteries, such as batteries having a pouch design or batteries having a prism design, and repeated layers in the batteries may be flat.

During use of other open pore cathodes, electrolytes may diffuse into the pores of the open pore cathode, which can reduce the lithium ion diffusion length and improve rate performance. The diffusion length is the average distance that an ion must travel before recombining. Various embodiments provided herein provide a coating layer at internal pore surfaces of open pore structure sintered cathodes to stabilize the cathode-electrolyte interface of the open pore structure sintered cathode. The coating layers that are formed provide protection for sintered cathodes from outside handling.

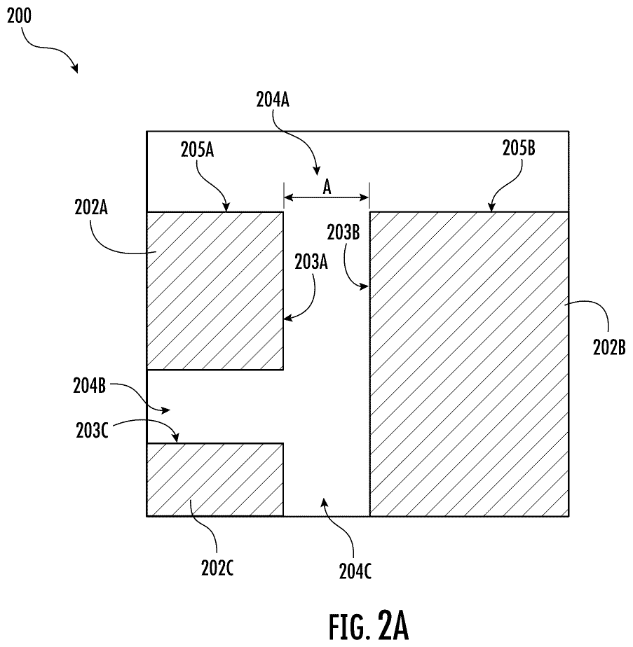

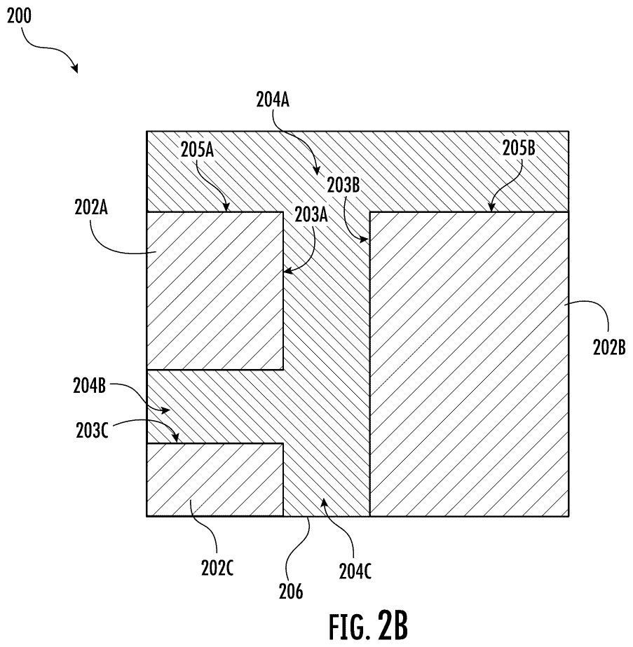

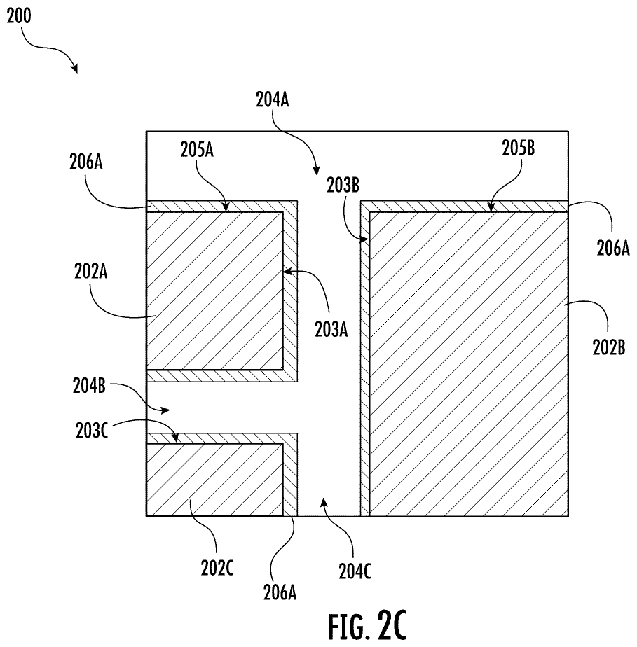

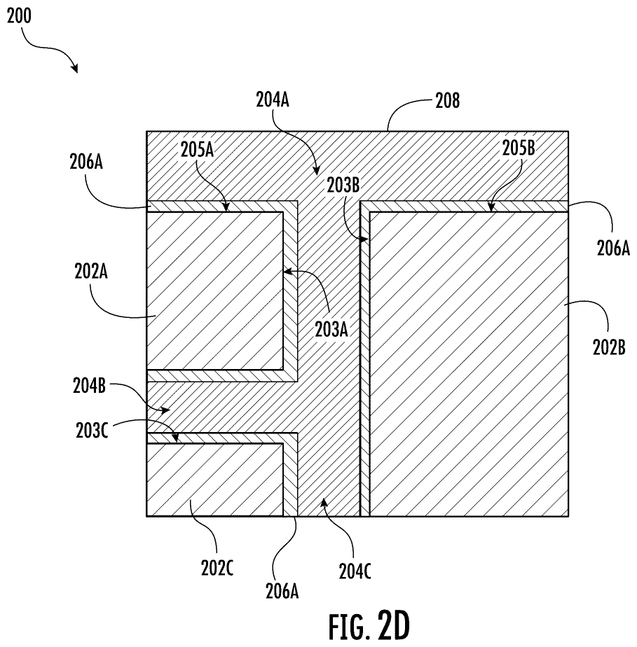

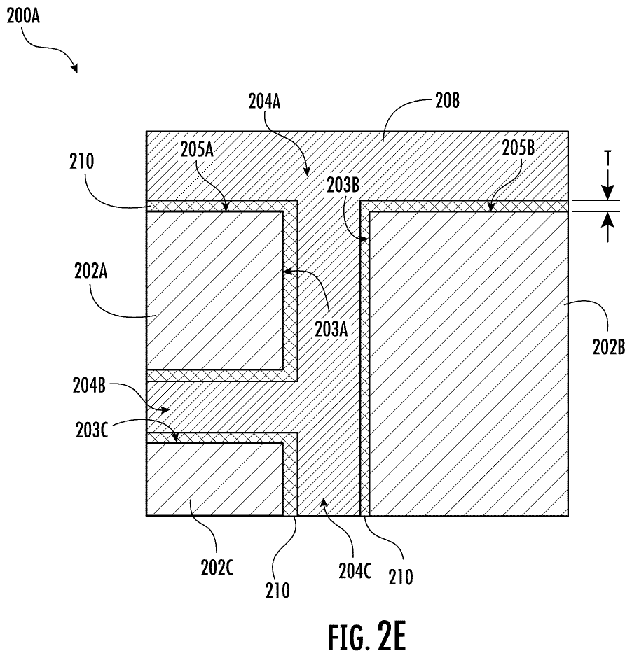

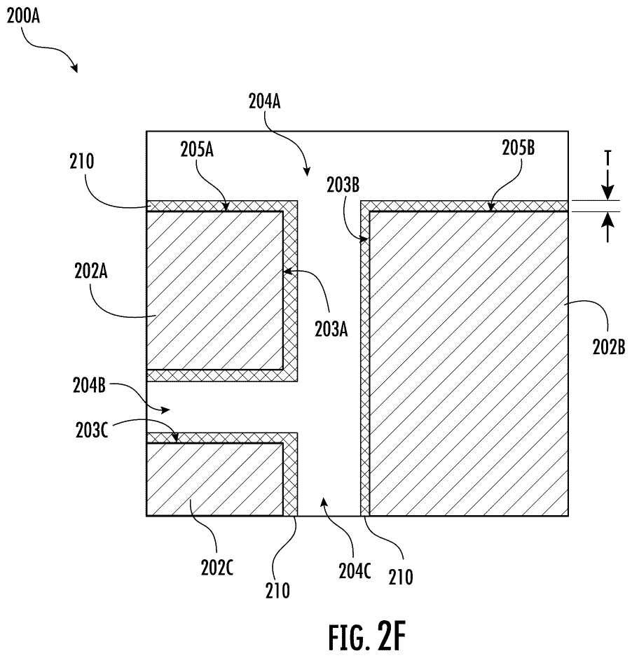

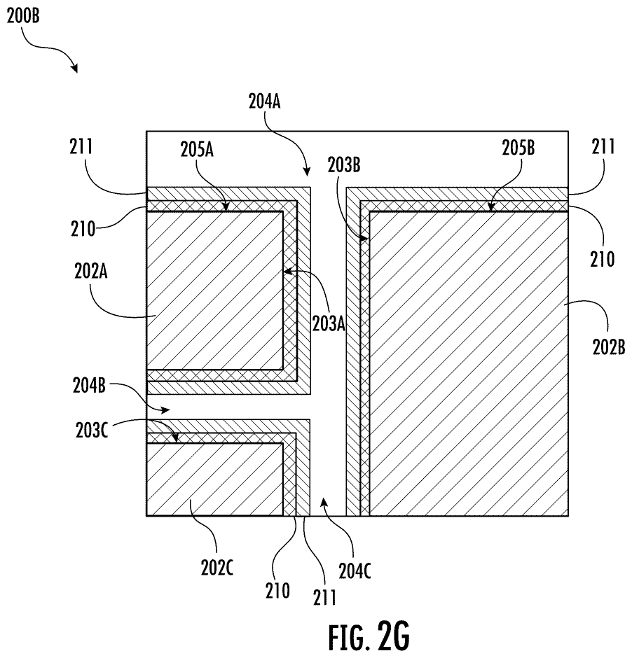

An ALD process may be used to form coating layers on a sintered cathode to form coated sintered cathodes. FIGS. 2A-2F illustrate the formation of a coated sintered cathode at various stages of an ALD process. Looking first at FIG. 2A, an example sintered cathode 200 is illustrated close-up and in isolation. The sintered cathode 200 comprises various structures including structures 202A, 202B, 202C. The sintered cathode 200 may be positioned in an ALD chamber so that the sintered cathode 200 may be exposed to other materials in a controlled environment.

The structures 202A-202C of the sintered cathode 200 may comprise a layered rock-salt structure such as LCO or NMC (LiNi_{(1-x-y)}MnₓCo_{y}O₂). In one embodiment, the NMC material may be NMC 111 material (LiNi_{1/3}Mn_{1/3}Co_{1/3}O₂).

The sintered cathode 200 has an open pore structure and comprises a plurality of pores between the structures 202A-202C. For example, a first pore 204A, a second pore 204B, and a third pore 204C are illustrated. The pores 204A-204C each possess a circular shape and a pore size A. In some embodiments, the pore size A may be a diameter, and pores 204A-204C may possess diameters of between 0.5 micrometers and 2 micrometers. However, pores 204A-204C are merely exemplary, and pores within other sintered cathodes 200 having an open pore structure may define non-circular cross sections and different sizes in other embodiments. In some embodiments, the porosity of the sintered cathodes may be between about ten percent and about thirty percent. The porosity levels may be tuned to the desired level in some embodiments.

The sintered cathode 200 comprises various surfaces, with some of these surfaces being inner pore surfaces and with other surfaces being external surfaces. For example, the sintered cathode 200 may comprise a first external surface 205A and a second external surface 205B. The sintered cathode 200 may also comprise a first inner pore surface 203A, a second inner pore surface 203B, and a third inner pore surface 203C.

After providing the sintered cathode 200, the sintered cathode 200 may be exposed to a precursor material 206 as illustrated in FIG. 2B. Where the sintered cathode 200 is positioned in an ALD chamber, the ALD chamber may be flooded with precursor material 206. The precursor material 206 may, for example, comprise trimethylaluminum (Al(CH₃)₃). The precursor material 206 may extend into the pores 204A-204C of the sintered cathode 200 and contact the inner pore surfaces 203A-203C. The precursor material 206 may also extend to the external surfaces 205A-205B. In embodiments, the sintered cathode 200 may be exposed to the precursor material for a period of time, such as 40 milliseconds (although other time periods are contemplated).

After exposing the inner pore surfaces 203A-203C and the external surfaces 205A-205B to the precursor material, some of the precursor material 206 may generally remain coated on the inner pore surfaces 203A-203C and the external surfaces 205A-205B. The precursor material 206 is then purged as illustrated in FIG. 2C, with some remaining precursor material 206A being coated to the inner pore surfaces 203A-203C and the external surfaces 205A-205B and with other precursor material 206 being removed. In some embodiments, the precursor material 206 is purged from the ALD chamber for a period of time, such as ten seconds (although other time periods are contemplated).

Additive material 208 may then be introduced, as illustrated in FIG. 2D. The additive material 208 extends into the pores 204A-204C and is therefore exposed to the remaining precursor material 206A. In some embodiments, the additive material 208 is oxygen (O₂), and the oxygen may be introduced in plasma form. However, the additive material 208 may take other forms such as with the addition of argon (Ar). The oxygen may be used in plasma form as an oxidant to avoid a chemical vapor deposition (CVD) reaction. In ALD approaches utilized by others, aluminum oxide (Al₂O₃) is deposited using tricthylaluminium (Al(CH₃)₃) and water. The water is often trapped in the pores and slows out-diffusion, resulting in CVD reactions near the surface of the materials. Additionally, where water is used as an oxidant to form an aluminum oxide (Al₂O₃) coating layer, there is a high concentration of hydroxide (OH). Hydroxide groups often react with electrolytes to form hydrogen fluoride (HF), causing dissolution of the aluminum oxide (Al₂O₃). Thus, the deposition of a coating layer comprising aluminum oxide (Al₂O₃) using oxygen (O₂) plasma having radicals with a short lifetime is better than ALD approaches using water. In some embodiments, remote plasma comprising oxygen (O₂) is used with a power of 300 watts for 5 seconds. In some embodiments, argon (Ar) plasma may be utilized.

After introducing the additive material 208, the additive material 208 reacts with the remaining precursor material 206A as illustrated in FIG. 2E. As a result of the reaction between the additive material 208 and the remaining precursor material 206A, a coating layer 210 is formed at the inner pore surfaces 203A-203C and the external surfaces 205A-205B. Thus, a coated sintered cathode 200A is formed. In some embodiments, the coating layer 210 comprises at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Sc), or phosphorous pentoxide (P₂O₅). The coating layer 210 may comprise a mixture of these materials as well, and the mixture may be provided as a single layer heterometallic compound or a multiple layer structure. The coating layer 210 may comprise materials that are doped with lithium in some embodiments. For example, the coating layer 210 may comprise aluminum oxide (Al₂O₃) that is doped with lithium, aluminum fluoride (AlF₃) that is doped with lithium, or lanthanum oxide (La₂O₃) that is doped with lithium.

The coating layer 210 defines a thickness (T). The thickness (T) may be less than about twenty nanometers in some embodiments. For example, the thickness (T) may be between about 0.2 nanometers and about twenty nanometers, such as in a range from about 0.2 nanometers to about 18 nanometers, in a range from about 0.2 nanometers to about 16 nanometers, in a range from about 0.2 nanometers to about 14 nanometers, in a range from about 0.2 nanometers to about 12 nanometers, in a range from about 0.1 nanometers to about 10 nanometers, in a range from about 0.2 nanometers to about 8 nanometers, in a range from about 0.2 nanometers to about 6 nanometers, in a range from about 0.2 nanometers to about 4 nanometers, in a range from about 0.2 nanometers to about 2 nanometers, in a range from about 0.2 nanometers to about 1 nanometer, in a range from about 0.2 nanometers to about 0.8 nanometers, in a range from about 0.2 nanometers to about 0.6 nanometers, or in a range from about 0.2 nanometers to about 0.4 nanometers, including all ranges and subranges therebetween. However, the coating layer 210 may possess different thicknesses (T) in other embodiments. For example, the thickness T may be in a range from about 0.4 nanometers to about 20 nanometers, in a range from about 0.6 nanometers to about 20 nanometers, in a range from about 0.8 nanometers to about 20 nanometers, in a range from about 1 nanometers to about 20 nanometers, in a range from about 2 nanometers to about 20 nanometers, in a range from about 4 nanometers to about 20 nanometers, in a range from about 6 nanometers to about 20 nanometers, in a range from about 8 nanometers to about 20 nanometers, in a range from about 10 nanometers to about 20 nanometers, in a range from about 12 nanometers to about 20 nanometers, in a range from about 14 nanometers to about 20 nanometers, in a range from about 16 nanometers to about 20 nanometers, or in a range from about 18 nanometers to about 20 nanometers, including all ranges and subranges therebetween. The thickness (T) of the coating layer 210 may be tuned to optimize the effect of the coating. In some embodiments, a thickness may be selected that is the minimum thickness that makes the surfaces of the coated sintered cathode 200A unreactive to electrolytes. Additionally, the coating layer 210 comprises a thickness uniformity of greater than about one percent, a thickness uniformity of greater than about one percent but less than about fifty percent, a thickness uniformity of greater than about fifty percent, or a thickness uniformity of less than or equal to about fifty percent. In some embodiments, the thickness uniformity may be measured by subtracting the minimum thickness from the maximum thickness and then by dividing this value by a value that is two times the average thickness.

After the coating layer 210 has been formed, the excess additive material 208 may be purged as illustrated in FIG. 2F. In the coated sintered cathode 200A illustrated in FIG. 2F, the coating layer 210 is coated on each of the inner pore surfaces 203A-203C. However, in some embodiments, the ALD methods illustrated in FIGS. 2A-2F may be utilized on a sintered cathode having a closed pore structure. Where this is the case, the coating layer 210 may be provided at the external surfaces 205A-205B to provide many of the benefits described herein, and, in some embodiments, the coating layer 210 may also be provided at any available inner pore surfaces.

In FIG. 2F, a coated sintered cathode 200A is illustrated having one coating layer, but other coated sintered cathodes are contemplated having multiple coating layers. FIG. 2G illustrates an example of another coated sintered cathode 200B having multiple coating layers. The coated sintered cathode 200B comprises the coating layer 210 and a second coating layer 211. The two coating layers 210, 211 may comprise different materials in some embodiments, with the second coating layer comprising aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅). However, the two coating layers 210, 211 may comprise the same materials in some embodiments, and the methods may be performed iteratively, such as to ensure that the coating layers 210, 211 have an increased overall thickness.

After the coated sintered cathode 200A having the coating layer 210 is obtained, further coating layers may be formed thereon by repeating the methods described above in reference to FIGS. 2A-2F. The coated sintered cathode 200A may be exposed to a precursor material, excess precursor material may be purged, additive material may be added to generate a reaction between the additive material and the remaining precursor material to form the second coating layer 211, and the excess additive material may then be purged. Further coating layers may be added using a similar approach. The methods illustrated in FIGS. 2A-2G may be conducted at a temperature of about 180 degrees Celsius to about 220 degrees Celsius, at a temperature of about 185 degrees Celsius to about 215 degrees Celsius, at a temperature of about 190 degrees Celsius to about 210 degrees Celsius, at a temperature of about 195 degrees Celsius to about 205 degrees Celsius, or at a temperature of about 200 degrees Celsius.

FIGS. 2A-2G are merely shown for purposes of explanation, and actual sintered cathodes and coated sintered cathodes may possess different geometries. While the pores illustrated in FIGS. 2A-2G have a rectilinear shape, actual pores may actually have other non-rectilinear shapes.

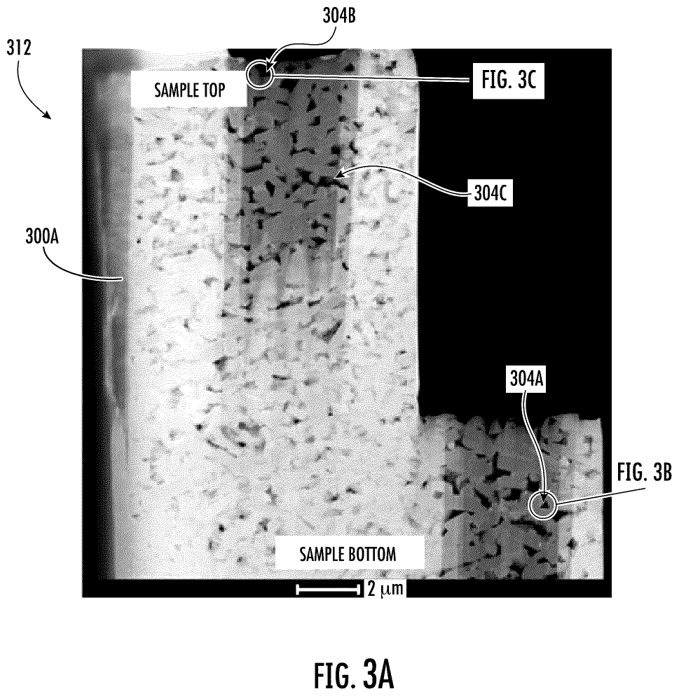

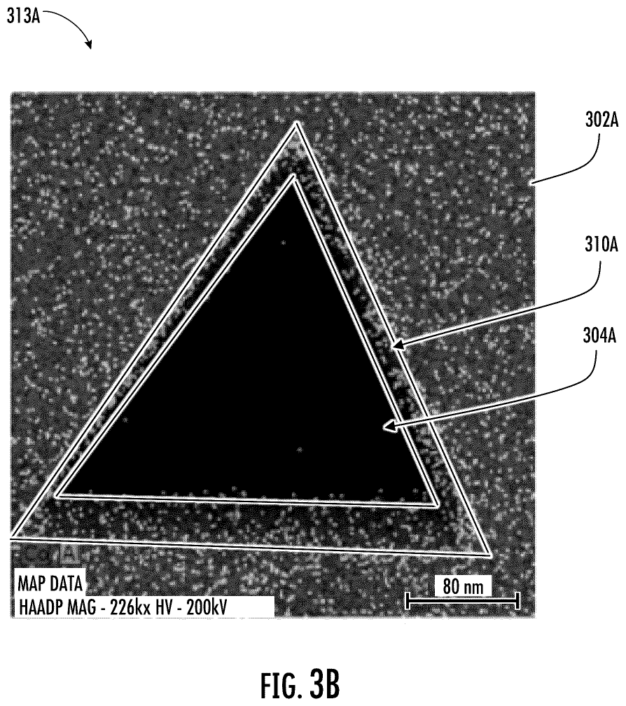

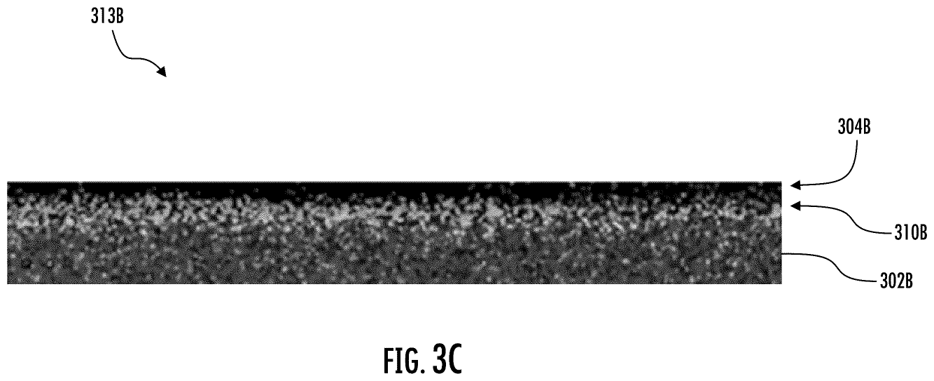

STEM images and EDS images were analyzed to evaluate the effectiveness of the ALD techniques, and the images confirm the effectiveness of the techniques in forming the coating layers. FIG. 3A illustrates a STEM image 312 of one example coated sintered cathode 300A comprising LCO material. The coated sintered cathode 300A included a 2-nanometer-thick coating layer comprising aluminum oxide (Al₂O₃) material, with this material coated on a sintered cathode comprising LCO material. The coating layer was formed using trimethylaluminum (Al(CH₃)₃) as a precursor, and the tricthylaluminium (Al(CH₃)₃) was converted into the aluminum oxide (Al₂O₃) material by plasma-assisted oxygen (O₂) burning.

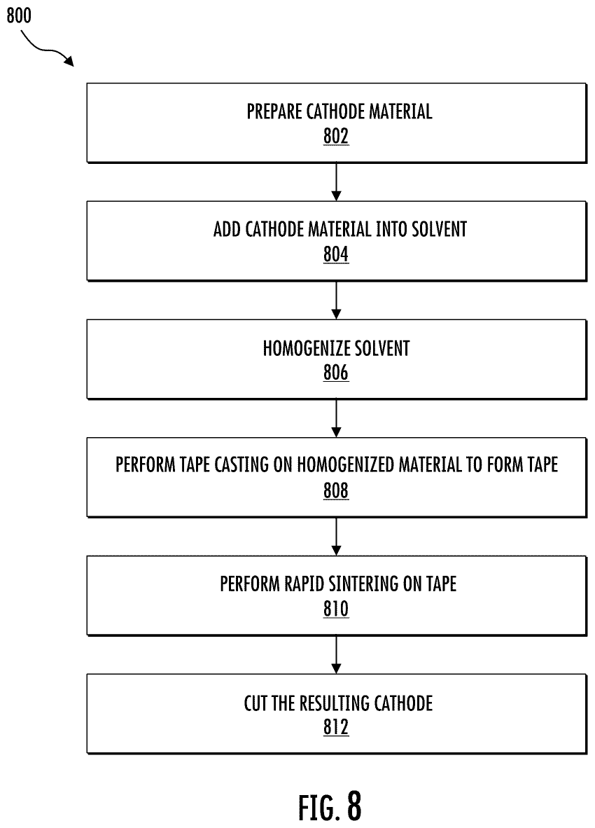

The LCO-based sintered cathode was processed by subjecting an LCO-based green tape (which has certain organic additives before sintering) to a sintering temperature of 975 degrees Celsius, at a pull speed of 5 centimeters per minute, with a cathode thickness of 17 micrometers, with a cathode diameter of 12.3 millimeters, and with a cathode porosity percentage of 11.7 percent. The pull speed was the speed that the material was pulled through a binder burn-out zone to pyrolyze organics. Before sintering, the LCO-based green tape comprised 93.17 percent LCO, 4.29 percent polyvinyl butyral binder, 1.27 percent Hypermer KD-1 dispersant, and 1.27 percent dibutyl phthalate, with all percentages being weight percentages. The LCO-based sintered cathode may be created using the method illustrated in FIG. 8 and described in the corresponding discussion herein. The polyvinyl butyral binder, Hypermer KD-1 dispersant, and dibutyl phthalate were burned off during sintering and cathode particles were sintered into an all-ceramic material. The LCO material in the LCO-based sintered cathode possessed an average diameter of 0.4 micrometers before sintering.

In the STEM image 312 of FIG. 3A, various pores are illustrated. For example, a first pore 304A, a second pore 304B, and a third pore 304C are illustrated. EDS images were obtained for the areas proximate to the first pore 304A and the second pore 304B. FIG. 3B is an enhanced EDS image 313A of the first pore 304A. The EDS image 313A illustrates the structure 302A of the coated sintered cathode 300A around the first pore 304A, with the structure 302A containing cobalt. The EDS image 313A also illustrates the presence of a coating layer 310A around the first porc 304A, with the coating layer 310A containing aluminum. Similarly, FIG. 3C is an enhanced EDS image 313B of the second pore 304B. The EDS image 313B illustrates the structure 302B of the coated sintered cathode 300A around the second pore 304B, with the structure 302B containing cobalt. The EDS image 313B also illustrates the presence of a coating layer 310B around the second pore 304B, with the coating layer 310B containing aluminum. Coating layers that were formed had a thickness of about two nanometers. The EDS images 313A, 313B revealed relatively uniform coating layers 310A, 310B on pore surfaces throughout the cathode.

Testing was also conducted to evaluate the electrical capacity of batteries with coated sintered cathodes relative to other batteries with uncoated sintered cathodes, and the testing revealed that batteries with coated sintered cathodes had an improved electrical capacity relative to other similar batteries with sintered cathodes that do not have any coating layer. The reduction in electrical capacity degradation is believed to be due to the separation of the sintered cathode from electrolytes using coating layers.

Testing was performed using a coated sintered cathode comprising NMC 111 material and an uncoated sintered cathode comprising NMC 111 material. Both possessed open pore structures. The coated sintered cathode that was tested had an aluminum oxide (Al₂O₃) coating layer with an average thickness of 2 nanometers. The NMC 111-based sintered cathode was formed by subjecting an NMC 111-based green tape to a sintering temperature of 1075 degrees Celsius, at a pull speed of 5 centimeters per minute, with a cathode thickness of 45 micrometers, with a cathode diameter of 12.3 millimeters, and with a cathode porosity percentage of 19.8 percent. The pull speed is the speed that the material was pulled through a binder burn-out zone to pyrolyze organics. Before sintering, the NMC 111-based green tape comprised 93.17 percent NMC 111, 4.29 percent polyvinyl butyral binder, 1.27 percent Hypermer KD-1 dispersant, and 1.27 percent dibutyl phthalate, with all percentages being weight percentages. The polyvinyl butyral binder, Hypermer KD-1 dispersant, and dibutyl phthalate were burned off during sintering and cathode particles were sintered into an all-ceramic material. The NMC 111 material in the NMC 111-based green tape possessed an average diameter of 0.4 micrometers before sintering. During testing, NMC 111-based sintered cathodes were provided in the form of coin cells and were constructed using lithium metal as an anode and lithium hexafluorophosphate (LiPF₆) at 1 M in a 1:1 mixture of ethylene carbonate and dimethyl carbonate solution. The NMC 111 sintered cathode may be created using the method illustrated in FIG. 8 and described in the corresponding discussion herein.

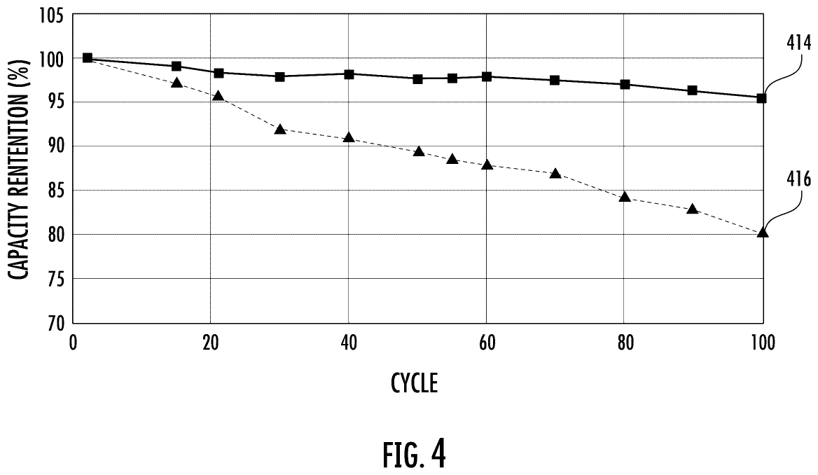

The results of this testing are illustrated in FIG. 4. The electrical capacity retention of a battery with a coated sintered cathode and the electrical capacity retention of a battery with an uncoated sintered cathode were evaluated after they each underwent a number of charge-discharge cycles. The charge-discharge cycles were conducted at 25 degrees Celsius with a current of 0.906 milliamperes per centimeter squared (0.5 C) in 3.0-4.3 volts. The first plotline 414 illustrates results for a coated sintered cathode, and the second plotline 416 illustrates results for an uncoated sintered cathode.

The testing results illustrated in FIG. 4 show that the battery with coated sintered cathodes performed better in terms of electrical capacity retention. The initial capacities of the batteries were both approximately 145 mAh/g. However, as charge-discharge cycles were performed, the first plotline 414 associated with the electrical capacity of a battery with coated sintered cathodes decreased in electrical capacity retention percentage at a lower rate than the second plotline 416 associated with the electrical capacity of a battery with uncoated sintered cathodes. After 100 charge-discharge cycles, the second plotline 416 dropped to around 80% of the initial electrical capacity. However, after 100 charge-discharge cycles, the first plotline 414 only dropped to around 95% of the initial electrical capacity. Thus, the aluminum oxide (Al₂O₃) coating layer in the coated sintered cathode improved electrical capacity retention of the tested batteries. The coated sintered cathodes caused batteries to have improved cycling stability, indicating that the coating improved cathode-electrolyte interface stability. These results tend to show that the coating layer separated the sintered cathode from electrolytes to reduce electrical capacity degradation in batteries.

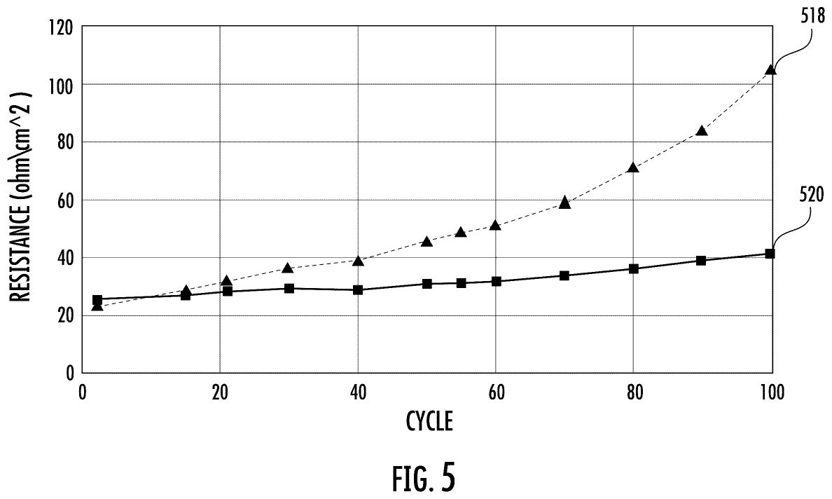

Testing was also conducted to evaluate the impedance level of batteries using coated sintered cathodes relative to batteries using otherwise identical uncoated sintered cathodes, and the testing revealed that batteries using coated sintered cathodes had a reduced impedance relative to the other batteries. The results of this testing are illustrated in the line graph of FIG. 5, with the line graph illustrating the resistance of a coated sintered cathode and an uncoated sintered cathode after they each undergo a number of charge-discharge cycles. In FIG. 5, the first plotline 518 is representative of the testing data for the batteries using an uncoated sintered cathode comprising NMC 111, and the second plotline 520 is representative of the testing data for the batteries using a coated sintered cathode having a coating layer comprising aluminum oxide (Al₂O₃) that is formed through ALD on a sintered cathode comprising NMC 111 material.

As illustrated in FIG. 5, the coating layer suppressed ohmic resistance increases during charge-discharge cycling tests. The rise in ohmic resistance is often attributable to reactions between a cathode and electrolytes, which creates an insulator layer on a surface of the cathode. The ohmic resistance was calculated using potential drop (ΔV) at the beginning of discharge process. The potential drop (ΔV) may be calculated using the equation ΔV=IR. At zero cycles, the first plotline 518 associated with the uncoated sintered cathode and the second plotline 520 associated with the coated sintered cathode were almost the same, with both having a resistance that was slightly above 20 Ω·cm². However, as charge-discharge cycles were conducted, the first plotline 518 associated with the uncoated sintered cathode increased in resistance at a significantly higher rate than the second plotline 520 associated with the coated sintered cathode. After just fifteen charge-discharge cycles, the resistance of the uncoated sintered cathode was greater than the resistance of the coated sintered cathode. After 100 charge-discharge cycles, the resistance of the uncoated sintered cathode was about 2.6 times as large as the resistance of the coated sintered cathode. After 100 charge-discharge cycles, the first plotline 518 associated with the uncoated sintered cathode was at a resistance of around 105 Ω·cm². By contrast, the second plotline 520 associated with the coated sintered cathode was at a resistance of around 41 Ω·cm².

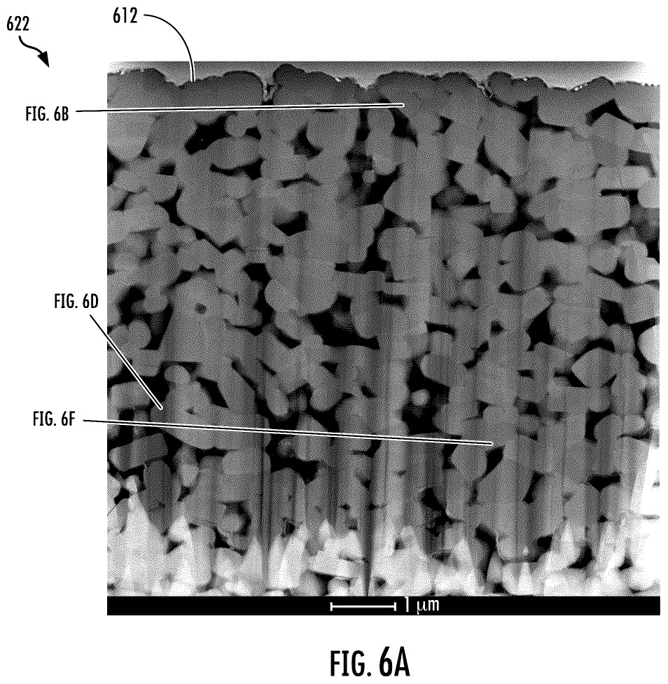

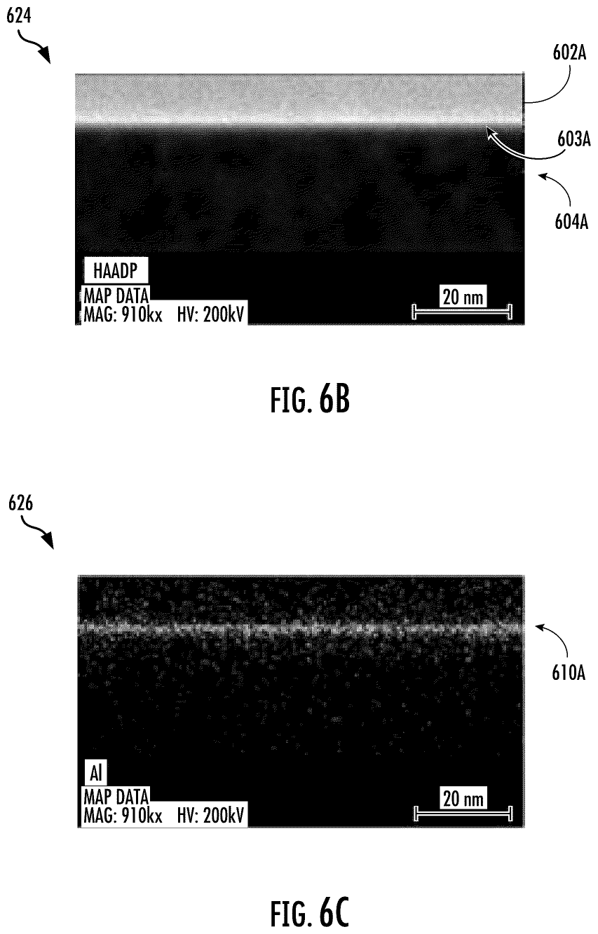

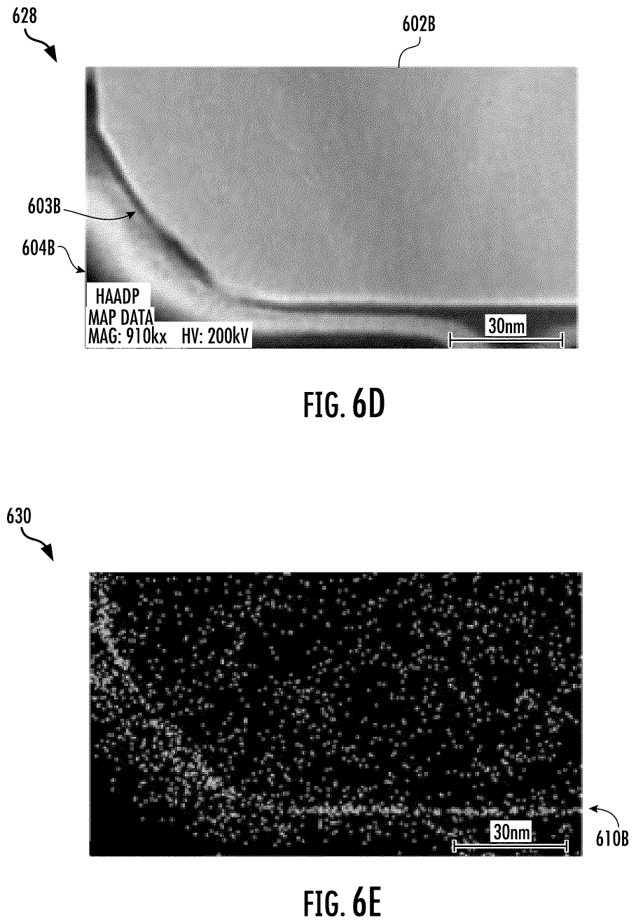

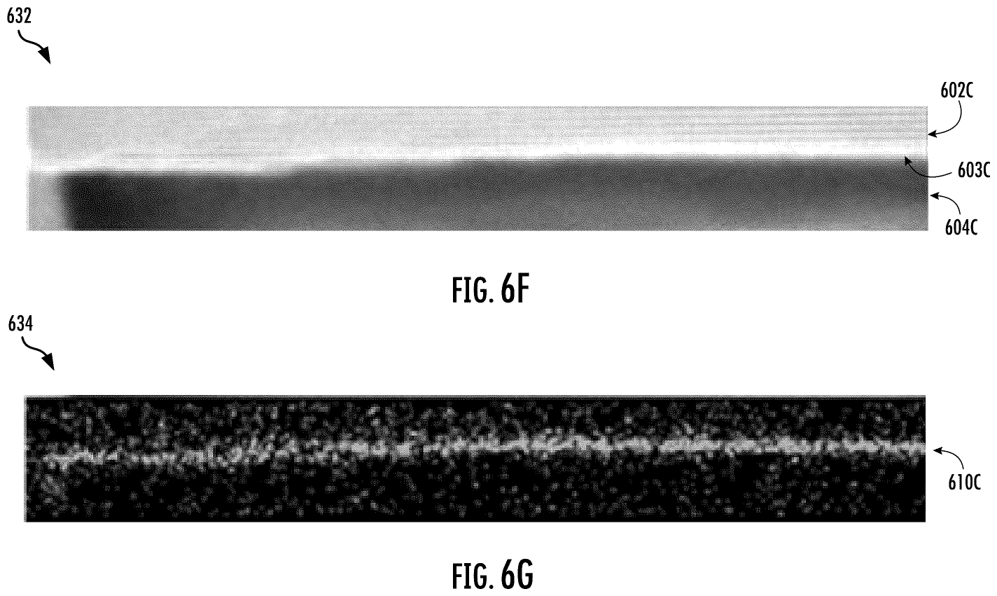

Even after one hundred charge-discharge cycles were conducted, STEM images and corresponding EDS images reveal that coating layers showed good stability and remained intact in coated sintered cathodes. FIG. 6A is a STEM image 622 illustrating an example coated sintered cathode 612 after one hundred charge-discharge cycles were conducted. The charge-discharge cycles were conducted at 25 degrees Celsius with a current density of 0.906 milliamperes per centimeter squared (0.5 C) in 3.0-4.3 volts.

Enhanced STEM images and EDS images were taken at various locations of the coated sintered cathode 612. In FIG. 6B, an enhanced STEM image 624 that was taken at a first location in the coated sintered cathode 612 is illustrated. The STEM image 624 illustrates a surface 603A on a structure 602A within the coated sintered cathode 612, with the surface 603A facing a pore 604A. FIG. 6C illustrates an enhanced EDS image 626 comprising an aluminum elemental map that was also taken at the first location in the coated sintered cathode 612. The EDS image 626 reveals the presence of a coating layer 610A, with the coating layer 610A conforming to the shape of the surface 603A. Thus, the STEM image 624 of FIG. 6B and the EDS image 626 of FIG. 6C tend to show that the coating layer 610A remained present on the surface 603A after one hundred charge-discharge cycles were performed.

Similarly, in FIG. 6D, an enhanced STEM image 628 that was taken at a second location in the coated sintered cathode 612 is illustrated. The STEM image 628 illustrates a surface 603B on a structure 602B within the coated sintered cathode 612, with the surface 603B facing a pore 604B. FIG. 6E illustrates an enhanced EDS image 630 showing an aluminum elemental map that was also taken at the second location in the coated sintered cathode 612. The EDS image 630 reveals the presence of a coating layer 610B, with the coating layer 610B conforming to the shape of the surface 603B. Thus, the STEM image 628 of FIG. 6D and the EDS image 630 of FIG. 6E tend to show that the coating layer 610B remained present on the surface 603B after one hundred charge-discharge cycles were performed.

Similarly, in FIG. 6F, an enhanced STEM image 632 that was taken at a third location in the coated sintered cathode 612 is illustrated. The STEM image 632 illustrates a surface 603C on a structure 602C within the coated sintered cathode 612, with the surface 603C facing a pore 604C. FIG. 6G illustrates an enhanced EDS image 634 showing an aluminum elemental map that was also taken at the third location in the coated sintered cathode 612. The EDS image 634 reveals the presence of a coating layer 610C, with the coating layer 610C conforming to the shape of the surface 603C. Thus, the STEM image 632 of FIG. 6F and the EDS image 634 of FIG. 6G show that the coating layer 610C remained present on the surface 603C after one hundred charge-discharge cycles were performed.

Methods for coating a sintered cathode by ALD to form a coated sintered cathode are also contemplated, and FIG. 7 is a flowchart illustrating an example of such a method. At operation 702, a sintered cathode is exposed to a precursor material. The sintered cathode may be positioned in an ALD chamber so that the sintered cathode 200 may be exposed to other materials in a controlled environment, and the ALD chamber may be flooded with precursor material at operation 702. The sintered cathode may comprise a layered rock-salt structure such as LCO, NMC, and/or NMC 111, and the precursor material may comprise trimethylaluminum (Al(CH₃)₃). In some embodiments, the sintered cathode may also comprise polyvinyl butyral binder, Hypermer KD-1 dispersant, and/or dibutyl phthalate before sintering, and the polyvinyl butyral binder, Hypermer KD-1 dispersant, and dibutyl phthalate may be pyrolyzed during the sintering process.

At operation 704, excess amounts of precursor material may be purged from the sintered cathode. Operation 704 may be performed before operation 706 so that the excess amount of precursor material is purged before exposing the sintered cathode and remaining precursor material to any additive material.

At operation 706, the sintered cathode and the precursor material are exposed to an additive material. The additive material may comprise, for example, oxygen (O₂). The additive material may be provided in plasma form. Exposing the sintered cathode and remaining precursor material to the additive material causes a coating layer to be formed on the sintered cathode. The coating layer comprises aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), and/or phosphorous pentoxide (P₂O₅). At operation 708, excess additive material may be purged. In some embodiments, the coating layer may comprise materials that are doped with lithium. For example, the coating layer may comprise aluminum oxide (Al₂O₃) that is doped with lithium, aluminum fluoride (AlF₃) that is doped with lithium, or lanthanum oxide (La₂O₃) that is doped with lithium.

At operation 710, a determination is made as to whether additional coating layers are to be added. Additional coating layers may be desirable to further increase the overall thickness of coating layers and to add different chemical properties for the coated sintered cathode. If additional coating layers are to be added, the method 700 proceeds back to operation 702 so that additional coating layers may be added to the already coated sintered cathode. If additional coating layers are not to be added, then the method 700 may be concluded.

In some embodiments, the method 700 may be performed such that the precursor material comprises triethylaluminium (Al(CH₃)₃) and the additive material comprises oxygen (O₂) (which may or may not be in plasma form), and the resulting coating layer may comprise aluminum oxide (Al₂O₃). ALD can deposit coating materials layer-by-layer at an atomic level. Furthermore, because the precursor material and the additive material are supplied separately, the method 700 is able to effectively control the coating thickness, compositions, and conformality, and the method 700 is able to achieve good penetration into porous structures. Thus, the method 700 is a suitable technique to coat surfaces of open pore or closed pore sintered cathodes.

The method 700 is merely one example embodiment of various methods contemplated herein. Unless noted otherwise, the operations of the method 700 may be performed in any order. Furthermore, additional operations may be added to the method 700, or some of the operations included in the method 700 may be omitted. For example, in some embodiments, no determination is made at operation 710, and the method 700 may be adapted so as to form a single coating layer.

Methods for making a sintered cathode are also contemplated, and FIG. 8 illustrates one method 800 for making a sintered cathode. The sintered cathode may comprise a layered rock-salt structure, and this layered rock-salt structure may comprise LCO or NMC. At operation 802, a cathode material may be prepared. The cathode material may be prepared so that the cathode material has a size appropriate for sintering. For example, the cathode material may be prepared so that it has a mean particle size of about 0.4 micrometers.

At operation 804, the cathode material may be added into a solvent. By doing so, a tape casting slurry may be prepared. The cathode material may be added to the solvent with the assistance of a dispersant such as Hypermer KD-1. Additionally, a binder and a plasticizer may be added into the solvent. In some embodiments, the binder and the plasticizer may be added into the solvent after the dispersant. The binder may comprise polyvinyl butyral (PVB), and the plasticizer may comprise dibutyl phthalate.

At operation 806, the solvent may then be allowed to homogenize to obtain a homogenized material. At operation 808, the homogenized material may be tape casted onto a polymer carrier to form a tape. The polymer carrier may comprise PET material, and the polymer carrier may be coated with a silicone release agent.

At operation 810, the tape may undergo rapid sintering. This may be accomplished by pulling the tape through a binder burn-out zone to pyrolyze organics and by moving the tape into a furnace where the material in the layered rock-salt structure sinters. In this rapid sintering process, the tape may be cooled and possibly winded. The pull speed during rapid sintering was about 5 centimeters per minute and the thickness of the sintered tape was about 17 micrometers.

At operation 812, the resulting cathode may be cut from the sintered cathode ribbon obtain the desired size. In some embodiments, the cathode may be cut through laser cutting. For example, the cathode may be laser cut from the sintered cathode ribbon to a diameter of about 15 millimeters.

Many modifications and other embodiments set forth herein will come to mind to one skilled in the art to which these embodiments pertain having the benefit of the teachings presented in the foregoing descriptions and the associated drawings. Therefore, the disclosure is not limited to the specific embodiments disclosed and modifications and other embodiments are intended to be included within the scope of the disclosure. Moreover, although the foregoing descriptions and the associated drawings describe example embodiments in the context of certain example combinations of elements and/or functions, different combinations of elements and/or functions may be provided by alternative embodiments without departing from the scope of the disclosure. In this regard, different combinations of elements and/or functions than those explicitly described above are also contemplated within the scope of the disclosure. Although specific terms are employed herein, they are used in a generic and descriptive sense only and not for purposes of limitation.

What is claimed is:

1. A coated sintered cathode comprising:
a sintered cathode comprising at least one of lithium cobalt oxide (LiCoO₂) or NMC (LiNi_{(1-x-y)}MnₓCo_{y}O₂); and
a coating layer coated on the sintered cathode and comprising at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅).

2. The coated sintered cathode of claim 1, wherein the coating layer is coated on the sintered cathode by atomic layer deposition.

3. The coated sintered cathode of claim 1, wherein a thickness of the coating layer is between about 0.2 nanometers and about twenty nanometers.

4. The coated sintered cathode of claim 1, wherein a thickness of the coating layer is less than about twenty nanometers.

5. The coated sintered cathode of claim 1, wherein the sintered cathode comprises an open pore structure and comprises a plurality of pores.

6. The coated sintered cathode of claim 5, wherein the sintered cathode comprises one or more inner pore surfaces, and the coating layer is coated on the one or more inner pore surfaces.

7. The coated sintered cathode of claim 5, wherein a porosity of the sintered cathode is between about ten percent and about thirty percent.

8. The coated sintered cathode of claim 5, wherein each pore of the plurality of pores has a pore size of about 0.5 micrometers to about 2 micrometers.

9. The coated sintered cathode of claim 1, wherein the sintered cathode comprises a closed pore structure.

10. The coated sintered cathode of claim 1, wherein the sintered cathode comprises lithium cobalt oxide (LiCoO₂).

11. The coated sintered cathode of claim 1, wherein the sintered cathode comprises NMC 111 (LiNi_{1/3}Mn_{1/3}Co_{1/3}O₂).

12. The coated sintered cathode of claim 1, wherein the coating layer comprises at least one of aluminum oxide (Al₂O₃) doped with lithium, aluminum fluoride (AlF₃) doped with lithium, or lanthanum oxide (La₂O₃) doped with lithium.

13. The coated sintered cathode of claim 1, wherein the coated sintered cathode is configured to be used in a battery, the coated sintered cathode configured to cause the battery to have a reduced impedance relative to a battery using an otherwise identical uncoated sintered cathode after fifteen or more charge-discharge cycles have been performed.

14. The coated sintered cathode of claim 1, wherein the coated sintered cathode is configured to be used in a battery, the coated sintered cathode is configured to improve the electrical capacity of the battery relative to a battery using an otherwise identical uncoated sintered cathode.

15. The coated sintered cathode of claim 1, further comprising:
a second coating layer comprising at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅), the coating layer and the second coating layer comprising different materials.

16. A method for coating a sintered cathode by atomic layer deposition to form a coated sintered cathode, the method comprising:
exposing the sintered cathode to a precursor material, the sintered cathode comprising a layered rock-salt structure and the precursor material comprising trimethylaluminum (Al(CH₃)₃);
exposing the sintered cathode and the precursor material to an additive material comprising oxygen (O₂) to form a coating layer on the sintered cathode, the coating layer comprising aluminum oxide (Al₂O₃).

17. The method of claim 16, wherein the sintered cathode comprises at least one of lithium cobalt oxide (LiCoO₂) or NMC (LiNi_{(1-x-y)}MnₓCo_{y}O₂).

18. The method of claim 16, further comprising purging excess precursor material from the sintered cathode before exposing the sintered cathode and the precursor material to the additive material.

19. The method of claim 16, wherein the additive material comprises a plasma.

20. A battery comprising:
a coated sintered cathode comprising:
a sintered cathode comprising at least one of lithium cobalt oxide (LiCoO₂) or NMC (LiNi_{(1-x-y)}MnₓCo_{y}O₂); and
a coating layer coated on the sintered cathode and comprising at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅), the coating layer coated on the sintered cathode by atomic layer deposition.

21. The battery of claim 20, wherein the sintered cathode forms a cathode-electrolyte interface inside the battery and the coating layer is positioned at the cathode-electrolyte interface.

22. The battery of claim 20, wherein the battery further comprises a solid electrolyte comprising at least one of lithium garnet, lithium phosophosilicate, or lithium phosphorus oxynitride.

23. The battery of claim 20, wherein a thickness of the coating layer is less than about twenty nanometers.

24. The battery of claim 20, wherein a thickness of the coating layer is between about 0.2 nanometers and about twenty nanometers.

25. The battery of claim 20, wherein the sintered cathode comprises an open pore structure and a plurality of pores.

26. The battery of claim 25, wherein the sintered cathode comprises one or more inner pore surfaces, the coating layer coated on the one or more of the inner pore surfaces.

27. The battery of claim 25, wherein a porosity of the sintered cathode is between about ten percent and about thirty percent.

28. The battery of claim 25, wherein each pore of the plurality of pores comprises a pore size of about 0.5 micrometers to about 2 micrometers.

29. The battery of claim 20, wherein the sintered cathode comprises a closed pore structure.

30. The battery of claim 20, wherein the sintered cathode comprises lithium cobalt oxide (LiCoO₂).

31. The battery of claim 20, wherein the sintered cathode comprises NMC 111 (LiNi_{1/3}Mn_{1/3}Co_{1/3}O₂).

32. The battery of claim 20, wherein the coating layer comprises at least one of aluminum oxide (Al₂O₃) doped with lithium, aluminum fluoride (AlF₃) doped with lithium, or lanthanum oxide (La₂O₃) doped with lithium.

33. The battery of claim 20, wherein the battery comprises a reduced impedance relative to another battery using an otherwise identical uncoated sintered cathode after fifteen or more charge-discharge cycles have been performed.

34. The battery of claim 20, wherein the coated sintered cathode is configured to improve the electrical capacity of the battery relative to a battery using an otherwise identical uncoated sintered cathode.

35. The battery of claim 20, further comprising:
a second coating layer comprising at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅), the coating layer and the second coating layer comprising different materials.

36. An energy storage device, comprising:
a sintered cathode; and
a coating layer coated on the sintered cathode and comprising at least one of aluminum oxide (Al₂O₃), aluminum fluoride (AlF₃), zinc oxide (ZnO), magnesium oxide (MgO), titanium dioxide (TiO₂), lanthanum oxide (La₂O₃), zirconium oxide (ZrO₂), gallium oxide (Ga₂O₃), magnesium fluoride (MgF₂), molybdenum trioxide (MoO₃), selenium (Se), or phosphorous pentoxide (P₂O₅),
wherein a thickness of the coating layer is between about 0.2 nanometers and about twenty nanometers.

37. The device of claim 36, wherein the coating encapsulates the sintered cathode.

38. The device of claim 37, wherein the sintered cathode comprises sintered polycrystalline lithium cobalt oxide (LiCoO₂) or NMC (LiNi_{(1-x-y)}MnₓCo_{y}O₂).

39. An energy storage device, comprising:
a cathode comprising sintered polycrystalline lithium cobalt oxide (LiCoO₂) and/or NMC (LiNi_{(1-x-y)}MnₓCo_{y}O₂); and
a coating layer coated on the cathode,
wherein a thickness of the coating layer is between about 0.2 nanometers and about twenty nanometers.

40. The device of claim 39, wherein the coating encapsulates the cathode.
